(19) United States
(12) Patent Application Publication
(10) Pub. No.: US 2007/0094073 A1
(43) Pub. Date: Apr. 26, 2007

(54) Advertisements for initiating and/or establishing user-advertiser telephone calls

(76) Inventors: Rohit Dhawan, San Francisco, CA (US); Kosar Jaff, Kirkland, WA (US); Scott Ludwig, Bellevue, WA (US); Ervin Perertz, Redmond, WA (US); Narayanan Shivakumar, San Jose, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/323,301

(22) Filed: Dec. 30, 2005

Related U.S. Application Data
(60) Provisional application No. 60/729,652, filed on Oct. 24, 2005.

(51) Int. Cl. G06Q 30/00

(52) U.S. Cl. 705/14

(57) ABSTRACT

Advertisements that facilitate telephonic communications between users and advertisers, and which avoid perceived problems or limitations of PPC and CTC offerings, are described. These advertisements may include offer information used to score the ad and/or to assess a charge to the advertiser in the event of a call conversion.

### § 0. RELATED APPLICATIONS

This application claims benefit to Provisional Application Ser. No. 60/729,652 (incorporated herein by reference), titled “IMPROVED ADVERTISEMENTS FOR INITIATING AND/OR ESTABLISHING USER-ADVERTISER TELEPHONE CALLS,” filed on Oct. 24, 2005, and listing Rohit Dhawan, Kosar Jaff, Scott Ludwig, Ervin Peretz and Shiva Shivakumar as the inventors.

### § 1. BACKGROUND OF THE INVENTION

§ 1.1 Field of the Invention

The present invention concerns advertising, such as advertising in an online environment. In particular, the present invention concerns helping advertisers generate telephone calls with users.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword relevant advertising has been used by search engines, such as the AdWords advertising system by Google, Inc. of Mountain View, Calif. (hereafter referred to as “Google”). Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors, and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. The AdSense system by Google is an example of a content-relevant advertising system.

In many online ad systems, one or more ads are displayed in association with a document, such as a search results page, or a Web page with content for example. Typically, online ads include embedded information (e.g., links) such that when the ad is selected (e.g., by a user clicking on the ad), a browser is loaded with a document (e.g., a Web page) associated with the ad. Such a document is commonly referred to as the “landing page” of the ad.

Although using Web pages, such as those authored in HTML or some other markup language for example, as ad landing pages is useful in many situations, some advertisers might prefer to have users contact them by telephone. For example, some advertisers might not have a Website or a sophisticated ad landing page As another example, some advertisers might find that they generate more sales, or higher margin sales, when a potential customer calls them versus when a potential customer visits their Website. In addition, some users might prefer to contact an advertiser by telephone. For example, some users might be more comfortable talking with a person, or might be using a client device that does not render Web pages well and/or on which it is difficult to enter information necessary to place an order for a product or service (e.g., due to display limited in terms of resolution and/or size, a slow connection speed, limited input means, limited processing power, etc.).

Some existing advertising networks use certain technologies for people to contact advertisers by telephone. These technologies may be referred to as “click to call” (or “CTC”) and “pay per call” (or “PPC”). Each of these technologies and their perceived limitations are introduced below.

PPC presents special toll-free numbers in advertisements or on Web pages. The use of such special toll-free numbers can be tracked so that advertisers can be billed on a per call basis when end users place calls to the special toll-free numbers. The company Ingenio of San Francisco, Calif. reportedly provides such technology to advertisers that run targeted advertisements on search engines such as AOL and FindWhat, as well as business that want to generate calls from their own Websites. Unfortunately, such implementations of PPC require a user to dial the advertiser. If such a user encounters a PPC toll free number on a device without call functionality, they might have to memorize or write down the toll free number, and access a telephone. This may be cumbersome in many situations and may dissuade a user from making a telephone call.

On the other hand, CTC allows a user to enter a number at which an advertiser may reach the user. Typically, when a user selects (e.g., clicks) an advertisement or a special icon in an advertisement, the user is presented with a screen or form that requests the user to enter a telephone number at which the advertiser can call the user back. A call server attempts to connect the advertiser and the user. If the user picks up the telephone at the number provided, the advertiser is able to speak with the user. The company eStara of Reston, Va. reportedly provides such technology to advertisers that advertise on Verizon's SuperPages^{SM}. Although CTC avoids making the user memorize or write down a special toll free number, CTC has been offered in ways that don't fully exploit its potential. Further, the eStara implementation of CTC apparently requires a user to click on an advertisement or an element of an advertisement before the user is presented with the screen or form that requests the user to enter their telephone number. Such a multi-window (or multi-page) approach may be confusing and cumbersome to some users.

In view of the foregoing, it would be useful to provide advertisements that facilitate telephone communications between users and advertisers, and which avoid perceived problems or limitations of PPC and CTC offerings.

### § 2. SUMMARY OF THE INVENTION

The present invention may be used to provide advertisements that facilitate telephone communications between users and advertisers, and which avoid perceived problems or limitations of PPC and CTC offerings. Embodiments consistent with the present invention may do so by (a) serving a set of one or more ads with a document, wherein at least one ad in the set of ad(s) is a click and pay to call ad, (b) accepting an end user conversion on the click and pay to call ad, (c) establishing a telephone connection between the end user and a party at a telephone number associated with the click and pay to call ad, and (d) assessing a charge to an account of an advertiser associated with the click and pay to call ad.

In at least some embodiments consistent with the present invention, the click and pay to call ad includes an offer per call, or a maximum offer per call.

In at least some embodiments consistent with the present invention, the click and pay to call ad includes executable code for accepting a call-back telephone number from the end user, or executable code for accepting a call-back telephone number stored on a client device.

In at least some embodiments consistent with the present invention, the accepted end user conversion on the click and pay to call ad includes an entry of a call-back telephone number and a selection of a connect element, or user interaction with the click and pay to call ad itself and not with any elements linked from the click and pay to call ad.

### § 3. BRIEF DESCRIPTION OF THE DRAWINGS

FIG. 1 is a high-level diagram showing parties or entities that can interact with an advertising system.

FIG. 2 is a diagram illustrating an environment in which, or with which, embodiments consistent with the present invention may operate.

FIG. 3 is a flow diagram of an exemplary method for selecting, serving and accounting for exemplary click and pay to call (“CPTC”) ads in a manner consistent with the present invention.

FIG. 4 is an exemplary search result page with an exemplary CPTC ad consistent with the present invention.

FIG. 5 is a diagram illustrating exemplary communications that may occur between exemplary components consistent with the present invention.

FIG. 6 is a block diagram of an exemplary apparatus that may be used to perform at least some operations, and store at least some information, in a manner consistent with the present invention.

### § 4. DETAILED DESCRIPTION

The present invention may involve novel methods, apparatus, message formats, and/or data structures for improving ads that facilitate user-advertiser telephone communications. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventors regard their invention to include any patentable subject matter described.

In the following definitions of terms that may be used in the specification are provided in § 4.1. Then, environments in which, or with which, embodiments consistent with the present invention may operate are described in § 4.2. Exemplary embodiments consistent with the present invention are described in § 4.3. Finally, some conclusions regarding the present invention are set forth in § 4.4.

### § 4.1 DEFINITIONS

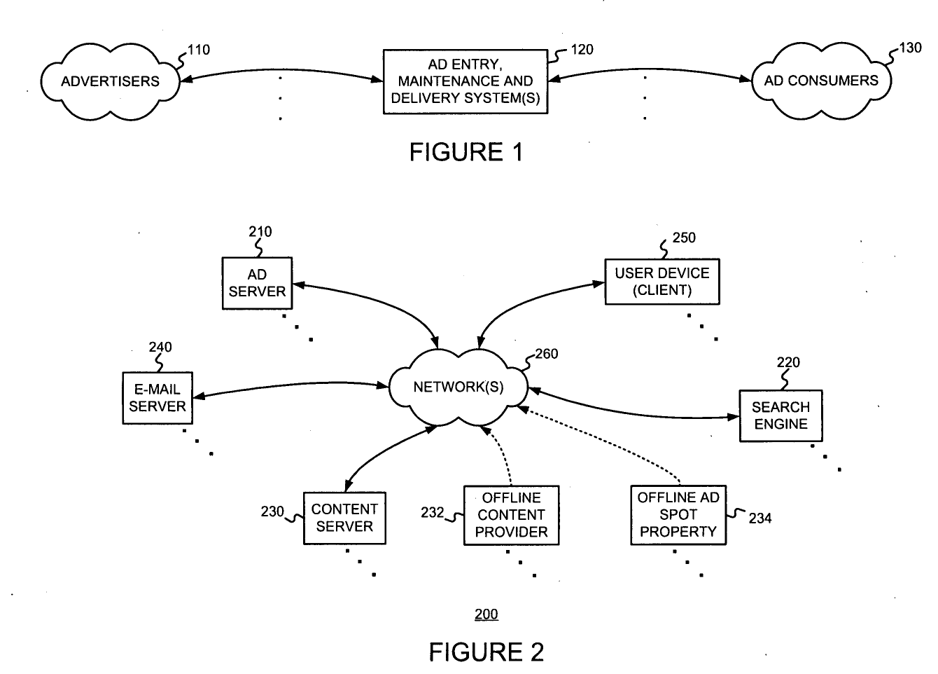

Online ads, such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, an advertiser telephone number, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the present invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user enters a call-back telephone number for purposes of allowing the advertiser to call them back. As another example, it may be the case that a conversion occurs when a user answers a telephone at a call-back number, thereby establishing a call between an advertiser and the user. As another example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### § 4.2 EXEMPLARY ADVERTISING ENVIRONMENTS IN WHICH, OR WITH WHICH, THE PRESENT INVENTION MAY OPERATE

FIG. 1 is a diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions In one embodiment consistent with the present invention, at least some of the ads may include code facilitate the establishment of a telephone call between a user and an advertiser. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 310 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads, including for example, CPTC ads consistent with the present invention, to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### § 4.3 EXEMPLARY EMBODIMENTS

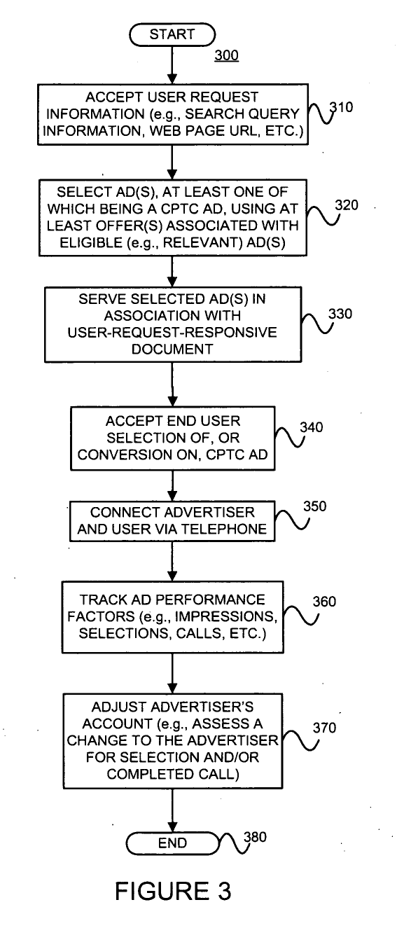

FIG. 3 is a flow diagram of an exemplary method 300 for selecting, serving and accounting for exemplary click and pay to call (“CPTC”) ads in a manner consistent with the present invention. User request information is accepted (Block 310), and one or more ads are selected (at least one of which is a CPTC ad) using at least offer (e.g., cost per impression, cost per selection, cost per conversion (e.g., call), maximum cost per impression, maximum cost per selection, maximum cost per conversion (e.g., call), etc.) information associated with eligible ads (Block 320). The selected ad or ads is then served in association with (e.g., within) a user-request-responsive document. (Block 330)

An end user may select an ad and/or may performs a conversion (e.g., initiate a call-back) on a CPTC ad. Suppose an end user performs a conversion on a CPTC ad. (Block 340) In response to such a conversion, an advertiser (or a proxy therefore) associated with the ad and the end user are connected via telephone. (Block 350) Ad performance factors (e.g. impressions, selections, conversions, etc.) may be tracked. (Block 360). The account of an advertiser associated with the CPTC ad converted on may then be adjusted (Block 370) before the method 300 is left (Node 380).

Referring back to block 310, user request information may be, for example, information about a search query entered by the user. As another example, the user request information may be an identifier of a requested document (e.g., a URL of a Web page).

Referring back to block 320, ads may be selected in various ways. For example, eligible ads may be first determined (e.g., ads relevant to search query information, ads relevant to the content of a document, ads targeted to the user that provided the request information, ads targeted to a client device or client device type on which the ads will be served, ads targeted to a country from which the user request originated, ads targeted to a time of day, day of week, month, season, time of year, etc. matching the time of the user request, etc.). Ads (e.g., eligible ads only) may be scored using at least offer information associated with the ads. In one exemplary embodiment consistent with the present invention, ads are provided with a score corresponding with an expected cost per impression (or “eCPM”). The eCPM may be simply an offer or maximum offer per impression associated with the ad, the product of an offer or maximum offer per selection and a selection rate associated with the ad, the product of an offer or maximum offer per conversion (e.g., call) and conversion rate associated with the ad, etc. Where there are multiple associated offers and rates, eCPM components may be summed to generate the score, or a maximum eCPM component may be used as the score. Recall from block 360 that such performance factors may be tracked. If there are a limited number of ads to be served, a final set of one or more ads may be selected using their scores. If there is more than one ad to be served with a document, the scores may be used to order the placement of the ads (or to assign other preferred serving parameters).

Referring back to block 320, in some embodiments consistent with the present invention, in some instances the ad(s) served do not necessarily need to include a CPTC, and the inclusion of the CPTC ad is for illustrative purposes.

The following example illustrates one possible way to score ads in a manner consistent with the present invention. In this example, ads may be scored using techniques described in U.S. patent application Ser. No. 11/228,583 (referred to as “the '583 application” and incorporated herein by reference), filed on Sep. 16, 2005, titled “FLEXIBLE ADVERTISING SYSTEM WHICH ALLOWS ADVERTISERS WITH DIFFERENT VALUE PROPOSITIONS TO EXPRESS SUCH VALUE PROPOSITIONS TO THE ADVERTISING SYSTEM,” and listing Sumit Agarwal, Gregory Joseph Badros and John Fu as the inventors. Assume that there are four eligible (e.g., relevant to a search query) ads—ad A, ad B, ad C and ad D—which include the following information:

Ad A:

MaxOffer per Selection: $1.00

Selection Rate: 0.08

Ad Landing Page: www.offleaseauto.com

Ad B:

MaxOffer per Call: $2.00

Call Rate: 0.06

Ad Contact Number: 650-987-6543

Ad C:

MaxOffer per Selection: $0.25

Selection Rate: 0.10

Ad Landing Page: www.carquote.com

MaxOffer per Call: $2.00

Call Rate: 0.05

Ad Contact Number: 650-123-4567

Ad D:

MaxOffer per Impression: $0.005

These ads may include additional information (e.g., creative content). Further, some or all of the information need not be visible or otherwise perceptible to the end user.

Ad A is not a CPTC ad, but a conventional ad that brings a user to a Web page when the user selects (e.g., clicks) the ad. The eCPM score for ad A is $0.08 (=$1.00*0.08). Ad B is a CPTC ad, having an eCPM score of $0.12 (=$2.00*0.06). Ad C is a CPTC ad that also has an ad landing page. In this way, users can either have a telephone call with the advertiser, or visit its Web page. The advertiser values calls more than click-throughs. The eCPM score for ad C is $0.125 (=$0.25*0.10+$2.00*0.05). Finally, ad D is not a CPTC ad, nor does it have an associated landing page. Rather, ad D is merely concerned with impressions (e.g., for brand building). The eCPM score for ad D is simply $0.005.

In this example, the ads could be rank ordered by score as ad C (0.125), ad B (0.12), ad A (0.08) and ad D (0.005). The score could be used to determine which ads to serve, and/or to order the placement of the ads (or to assign other preferred serving parameters).

Suppose that ad C is served and that the end user converts on the ad (requests a call-back (and picks up the call-back telephone)). The advertiser associated with ad C could be assessed a charge of $2.00 (perhaps subject to price discounting, such price discounting using the techniques described in U.S. patent application Ser. No. 10/340,543 (incorporated herein by reference and referred to as “the '543 application”), filed on Jan. 10, 2003, titled “AUTOMATED PRICE MAINTENANCE FOR USE WITH A SYSTEM IN WHICH ADVERTISEMENTS ARE RENDERED WITH RELATIVE PREFERENCES,” and listing Eric Veach and Salar Arta Kamangar as inventors, or U.S. patent application Ser. No. 10/340,542 (incorporated herein by reference and referred to as the '542 application), filed on Jan. 10, 2003, titled “AUTOMATED PRICE MAINTENANCE FOR USE WITH A SYSTEM IN WHICH ADVERTISEMENTS ARE RENDERED WITH RELATIVE PREFERENCE BASED ON PERFORMANCE INFORMATION AND PRICE INFORMATION,” and listing Eric Veach and Salar Arta Kamangar as inventors, for example).

Referring back to block 370, an advertiser may be assessed a charge when its CPTC ad is converted on. For example, if the advertiser associates a cost per conversion (call) offer with its ad, it may be assessed an amount corresponding to the offer. As another example, if the advertiser associates a maximum cost per conversion (call) offer with its ad, it may be assessed an amount that is equal to the maximum offer, or less than the maximum offer. Price discounting techniques such as those described in the '543 application or the '542 application, for example, may be used.

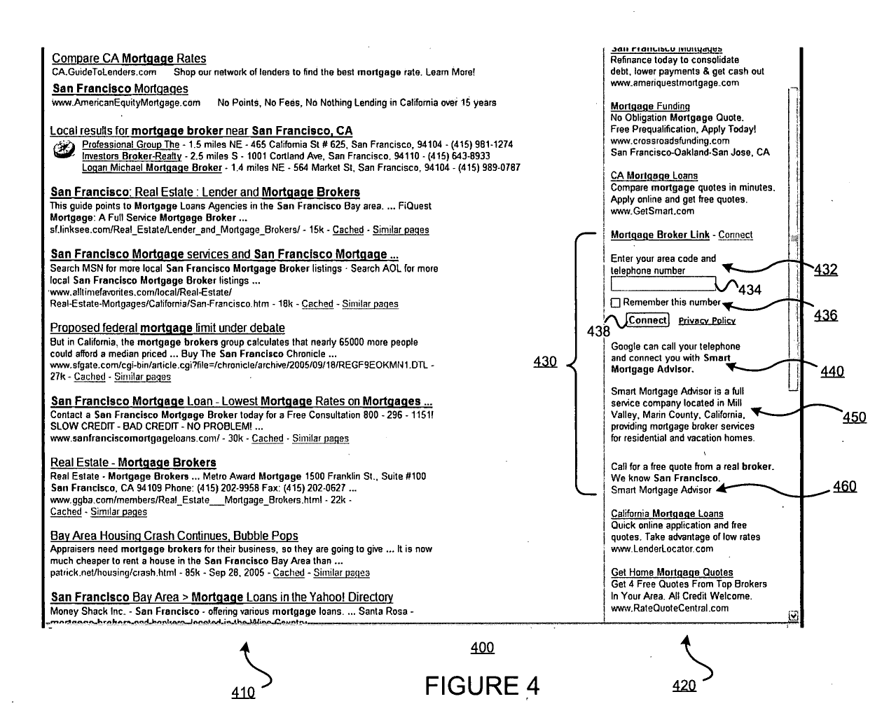

FIG. 4 is an exemplary search result page portion 400 with an exemplary CPTC ad 430 consistent with the present invention. As shown, the search results page portion 400 includes search results 410 on the left (with two ads and local search results at the top) and targeted ads 420 on the right. The targeted ads include a CPTC ad 430 consistent with the present invention. As shown, the CPTC ad 430 includes a box element 434 for a user to enter a call-back number (with area code), which is associated with informational text 432. The user can then submit an entered call-back telephone number by selecting the “connect” button element 438, which is explained with informational text 440. Doing so will initiate a call back from the advertiser. The ad 430 may also include a check box element 436 which allows the user to have the CPTC ad server (or some other component, such as the client device for example) remember (e.g., store) the entered telephone number.

The CPTC ad 430 may also include creative text 450 and “visible” URL information 460 provided by the advertiser.

Note that the CPTC ads are not limited to the exemplary ad 430.

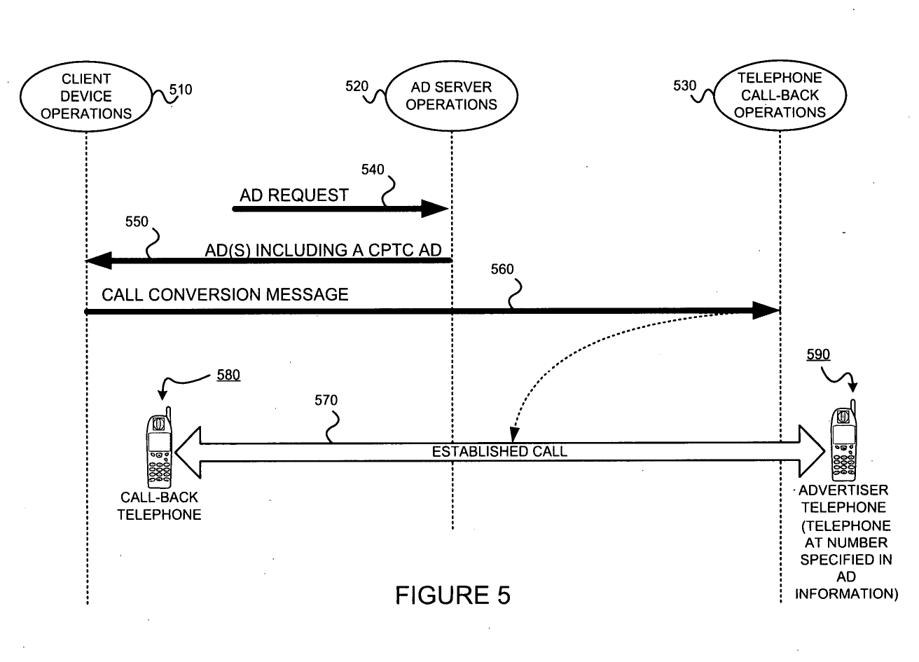

FIG. 5 is a diagram illustrating exemplary communications that may occur between exemplary components consistent with the present invention. An ad request is received by ad server operations 520 as indicated by communication 540. The ad request may have been sourced from a search engine, script on a Web page, etc. In response to the ad request, ad server operations 520 determine a set of one or more ads. In this example, it is assumed that the set of ad(s) includes at least one CPTC ad. As indicated by communication 550, the set of ad(s) is provided to client device operations 510 for rendering. For example, the client device operations 510 may include a browser which renders the ads.

In this example, it is assumed that the end user at the client device requests that an advertiser associated with a CPTC ad call it back at a provided telephone number. The telephone number may have been entered by the end user or previously stored by or at the client device. As indicated by communication 560, a call conversion message 560 is provided to telephone call-back operations 530. This communication 560 may include the telephone number associated with the CPTC ad by the advertiser and the call-back telephone number. It 560 may also include an ad identifier, serving parameter(s), etc. The telephone call-back operations 530 establish a call between the advertiser telephone 590 and the call-back telephone 580 (assuming both parties answer their telephones) as indicated by 570.

### § 4.3.4 EXEMPLARY APPARATUS

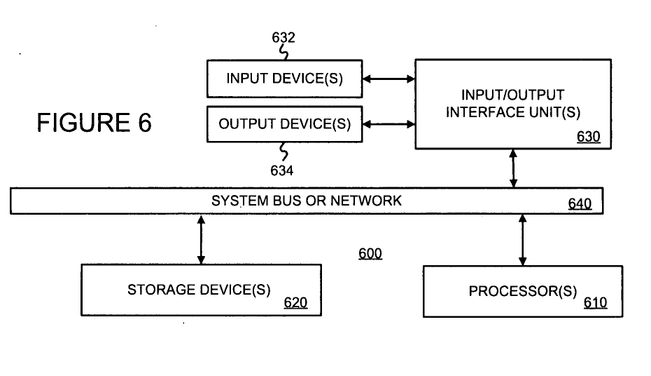

FIG. 6 is high-level block diagram of a machine 600 that may perform one or more of the operations discussed above. The machine 600 includes one or more processors 610, one or more input/output interface units 630, one or more storage devices 620, and one or more system buses and/or networks 640 for facilitating the communication of information among the coupled elements. One or more input devices 632 and one or more output devices 634 may be coupled with the one or more input/output interfaces 630.

The one or more processors 610 may execute machine-executable instructions (e.g., C or C++ running on the Solaris operating system available from Sun Microsystems Inc. of Palo Alto, Calif., the Linux operating system widely available from a number of vendors such as Red Hat, Inc. of Durham, N.C., the BREW or J2ME applications platforms, the Symbian operating system from Symbian of London, UK, Java, assembly, Perl, etc.) to effect one or more aspects of the present invention. At least a portion of the machine executable instructions may be stored (temporarily or more permanently) on the one or more storage devices 620 and/or may be received from an external source via one or more input interface units 630.

In one embodiment, the machine 600 may be one or more conventional personal computers, mobile telephones, PDAs, etc. In the case of a conventional personal computer, the processing units 610 may be one or more microprocessors. The bus 640 may include a system bus. The storage devices 620 may include system memory, such as read only memory (ROM) and/or random access memory (RAM). The storage devices 620 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 632, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 610 through an appropriate interface 630 coupled to the system bus 640. The output devices 634 may include a monitor or other type of display device, which may also be connected to the system bus 640 via an appropriate interface. In addition to (or instead on the monitor, the personal computer may include other (peripheral) output devices (not shown), such as speakers and printers for example.

Referring back to FIG. 2, one or more machines 600 may be used as ad server 210, search engine 220, content server 230, e-mail server 240, and/or user device 250 (e.g., a computer, a mobile telephone, etc.).

### § 4.3.5 ALTERNATIVES AND EXTENSIONS

As can be appreciated from FIG. 5, a Call and Pay to Click CPTC ad serving system may be implemented as a three-part system—a client component, an ad server component, and a server telephony component. The client component may be implemented to allow the client (e.g., a Personal Computer running a World Wide Web browser, or any similar device running a web browser such as a mobile phone) to present the end user (the person using the web browser) with options regarding how they want to communicate with the advertiser. Such options may include, for example, placing a call from the PC to the advertiser's telephone, being connected to the advertiser, telephone-to-telephone, etc. The ad server component may provide the usual advertisement(s) targeted at the user's search query, and in addition may respond to the user's selection (e.g., what the user “clicks on” in from the client-side). This ad server component may then pass the appropriate request to the server telephony component. The server telephony component may place appropriate communications requests to establish a call between a telephone at a specified call-back number and the target merchant. This may involve a call to the Public Switched Telephony Network (PSTN) which encompasses “land” and “mobile” lines. Alternatively, or in addition, other telephony networks (e.g., VoIP networks) may be used.

As can be appreciated from the foregoing, a user who enters a search query, or otherwise performs a targeted search, may be presented with advertisements for advertisers who are willing to accept telephone calls from their paid advertisement. If the user clicks on the advertisement, a user interface guides the process to establish a telephone call between the user (at specified call-back number) and the advertiser. This user interface can either present a PC-based experience, whereby the call is placed using Voice Over IP (VoIP) technologies on the PC, or the user can receive a telephone call to a designated number, which then connects the user to the desired advertiser on whose advertisement the user clicked.

In at least some embodiments consistent with the present invention, the system determines the best course of action based on user input (preferences, selections, etc.), as well as on practical constraints such as whether the user's PC has a microphone or speakers. If the user's PC does not qualify (if it doesn't have telephony functionality), or if the user explicitly selects a non-PC-based call, the server telephony component may dial the user via a telephone number in order to connect them with the advertiser.

In at least some embodiments consistent with the present invention, the system may remember the telephone number that users enter so that they do not have to enter the number repeatedly upon repeated use of the system (repeated conversions on CPTC ads). This may be done, for example, via a browser “cookie” on the client, or via log in to an account managed by, or accessible to, the advertising network. Using either method, a user's telephone number entry (or entries) may be conveniently entered by the system automatically so that a series of advertisements can be quickly converted-on (e.g., with a simple selection of a “connect by telephone” option, such as a simple click on a “connection by telephone” button element). This is particularly useful where the user wants to talk with multiple merchants, and allows the system to connect the user to the advertisers rapidly, in succession.

In at least some embodiments consistent with the present invention, advertisers who use this system to place CPTC advertisements (with telephone numbers) use the same auction-based system that is used in Google AdWords. The new element that this system introduces is the ability to target advertisements with different auction values based on whether the user converts on the CPTC ad (e.g., selects a telephone call as the means to communicate with the advertiser).

Recall from exemplary ad C above that it is also possible to place hybrid advertisements that contain both traditional Web page links, as well as telephone links. In such a system, the advertiser may specify separate offers, such as one for clicks and another for calls. In this way, an advertiser can direct their advertising budget in a flexible fashion to encourage Web traffic and/or to encourage telephone traffic through differing bids for different advertising campaigns. Thus, advertisers can chose to offer different amounts for document (e.g., Web page) load-on-selection and call-on-selection. Performance parameters for each can be tracked separately.

At least some embodiments consistent with the present invention may employ means which prevent users from repeatedly calling telephone numbers in a prank fashion. Providing such means would help make the system less prone to abuse.

In alternative embodiments consistent with the present invention, advertisers could be assessed a charge for each call they receive through from standard online Yellow Pages-based calling. For example, if a conversion on a CPTC ad in an online directory occurs, the advertiser may be notified that the telephone call came from a lead generated through an online director service. The advertisers could then pay for that CPTC ad conversion through their phone bill in the form of a phone charge (similar to high toll phone services such as 900 and 976 numbers). In such a case, the CPTC ad need not have an offer associated with it.

In at least some embodiments consistent with the present invention, the advertiser telephone number associated with a CPTC ad may be to an audio document (e.g., a voice message) or a live operator, depending on the telephone number specified by the advertiser. A CPTC ad may have different buttons can be used by a user to select whether the call-back will be with an audio document or a live operator.

In at least some embodiments consistent with the invention, selecting an ad or a button on an ad may initiate both a call-back and a document-load. The call-back initiation and document-load initiation may occur in parallel or in series. In still another alternative embodiment consistent with the present invention, a limited document (e.g., in terms of time to load and render) with one or more call-back-on-select links can be loaded in response to an ad selection. For example, rather than load a large Web page, a limited document stating:
CLICK HERE TO HAVE A TRAVEL AGENT CALL YOU BACK
CLICK HERE TO HAVE US CALL YOU ABOUT SPECIAL PROMOTIONS
   may be loaded. Conversions may be defined (and bid on by advertisers) in flexible ways (e.g., a user action, or a specific sequence of user actions, a specific set of user actions, etc.).

Although some of the exemplary embodiments described the use of a browser, at least some embodiments consistent with the present invention may use some other content rendering application or device.

Referring back to FIG. 4, in at least some embodiments consistent with the present invention, an area code portion of a call-back telephone number (to be entered in box 434) may be automatically determined (e.g., from an Internet Protocol (“IP”) address of the client device). See, for example, the area codes of the telephone numbers of the “local results” towards the top of the screen portion 400. Such automatically determined area code information may be displayed within the box 434 or to the immediate left of the box 434, for example.

The term “call-back” should not be construed as requiring a call to be placed from an advertiser to a call-back number. For example, the call may be established as a conference call.

In at least some embodiments consistent with the present invention, the telephone number specified by the advertiser in association with its CPTC ad may be the first telephone number of a hunt group.

In at least some embodiments consistent with the present invention, a call-back is not automatically established or initiated. In such alternative embodiments, the advertiser may be provided with the call-back number provided by the end user (or the client device). The advertiser may then call-back the number later.

In at least some embodiments consistent with the present invention, the advertisement may include executable code to allow the advertiser to specify a call-back time (absolute or relative to the time of the conversion), day, and/or date, or a range thereof.

At least some embodiments consistent with the present invention may be used in concert with techniques described in U.S. patent application Ser. No. 10/880,868 (referred to as “the '868 application” and incorporated herein by reference), filed on Jun. 30, 2004, titled “ADVERTISEMENTS FOR DEVICES WITH CALL FUNCTIONALITY, SUCH AS MOBILE PHONES”, and listing Shumeet Baluja as the inventor.

### § 4.4 CONCLUSIONS

As can be appreciated from the foregoing, embodiments consistent with the present invention may be used to provide advertisements that facilitate telephone communications between users and advertisers, and which avoid perceived problems or limitations of PPC and CTC offerings.

What is claimed is:

1. A computer-implemented method comprising:
a) accepting user request information;
b) selecting, from a plurality of ads, a set of one or more ads using at least offers associated with the ads, wherein at least one ad in the set of one or more ads is a click and pay to call ad;
c) serving the selected set of one or more ads with a user-request-responsive document;
d) accepting an end user conversion on the click and pay to call ad;
e) establishing a telephone connection between the end user and a party at a telephone number associated with the click and pay to call ad; and
f) assessing a charge to an account of an advertiser associated with the click and pay to call ad.

2. The computer-implemented method of claim 1 wherein the user request information includes information from a search query.

3. The computer-implemented method of claim 1 wherein the user request information includes a document identifier.

4. The computer-implemented method of claim 1 wherein the user request information includes a URL of a Web page.

5. The computer-implemented method of claim 1 wherein the offer associated with the click and pay to call ad includes an offer per call.

6. The computer-implemented method of claim 1 wherein the offer associated with the click and pay to call ad includes a maximum offer per call.

7. The computer-implemented method of claim 1 wherein the click and pay to call ad includes executable code for accepting a call-back telephone number from the end user.

8. The computer-implemented method of claim 1 wherein the click and pay to call ad includes executable code for accepting a call-back telephone number stored on a client device.

9. The computer-implemented method of claim 1 wherein the accepted end user conversion on the click and pay to call ad includes an entry of a call-back telephone number and a selection of a connect element.

10. The computer-implemented method of claim 1 wherein the accepted end user conversion on the click and pay to call ad includes user interaction with the click and pay to call ad itself and not with any elements linked from the click and pay to call ad.

11. The computer-implemented method of claim 1 further comprising:
tracking the serving of the click and pay to call ad and any other click and pay to call ads; and
tracking conversions on the click and pay to call ad and any other click and pay to call ads.

12. The computer-implemented method of claim 11 wherein the conversions tracked include end user entry of a call-back telephone number.

13. The computer-implemented method of claim 11 wherein the conversions tracked include end user entry of a call-back telephone number and the establishment of a telephone connection between the end user and a party at a telephone number associated with the click and pay to call ad.

14. A computer-implemented method comprising:
a) serving a set of one or more ads with a document, wherein at least one ad in the set of one or more ads is a click and pay to call ad;
b) accepting an end user conversion on the click and pay to call ad;
c) establishing a telephone connection between the end user and a party at a telephone number associated with the click and pay to call ad; and
d) assessing a charge to an account of an advertiser associated with the click and pay to call ad.

15. The computer-implemented method of claim 14 wherein the click and pay to call ad includes an offer per call.

16. The computer-implemented method of claim 14 wherein the click and pay to call ad includes a maximum offer per call.

17. The computer-implemented method of claim 14 wherein the click and pay to call ad includes executable code for accepting a call-back telephone number from the end user.

18. The computer-implemented method of claim 14 wherein the click and pay to call ad includes executable code for accepting a call-back telephone number stored on a client device.

19. The computer-implemented method of claim 14 wherein the accepted end user conversion on the click and pay to call ad includes an entry of a call-back telephone number and a selection of a connect element.

20. The computer-implemented method of claim 14 wherein the accepted end user conversion on the click and pay to call ad includes user interaction with the click and pay to call ad itself and not with any elements linked from the click and pay to call ad.

21. The computer-implemented method of claim 14 further comprising:
tracking the serving of the click and pay to call ad and any other click and pay to call ads; and
tracking conversions on the click and pay to call ad and any other click and pay to call ads.

22. The computer-implemented method of claim 21 wherein the conversions tracked include end user entry of a call-back telephone number.

23. The computer-implemented method of claim 21 wherein the conversions tracked include end user entry of a call-back telephone number and the establishment of a telephone connection between the end user and a party at a telephone number associated with the click and pay to call ad.

24. Apparatus comprising:
a) means for serving a set of one or more ads with a document, wherein at least one ad in the set of one or more ads is a click and pay to call ad;
b) means for accepting an end user conversion on the click and pay to call ad;
c) means for establishing a telephone connection between the end user and a party at a telephone number associated with the click and pay to call ad; and
d) means for assessing a charge to an account of an advertiser associated with the click and pay to call ad.

25. A computer-readable medium having stored thereon computer-executable instructions which, when executed by a computer, perform a method comprising:
a) serving a set of one or more ads with a document, wherein at least one ad in the set of one or more ads is a click and pay to call ad;
b) accepting an end user conversion on the click and pay to call ad;
c) establishing a telephone connection between the end user and a party at a telephone number associated with the click and pay to call ad; and
d) assessing a charge to an account of an advertiser associated with the click and pay to call ad.

26. A computer-readable medium having stored thereon computer-readable information associated with an ad, the computer-readable information comprising:
a) ad creative information;
b) executable code for accepting a call-back telephone number; and
c) offer information related to a call-back operation performed by an end user in association with the ad.

27. The computer-readable medium of claim 26 wherein the offer information includes an offer per entry of a call-back telephone number.

28. The computer-readable medium of claim 26 wherein the offer information includes a maximum offer, subject to discounting, per entry of a call-back telephone number

29. The computer-readable medium of claim 26, the computer-readable information associated with an ad further comprising:
d) a telephone number,
wherein the offer information includes an offer per establishment of a telephone call between an entered call-back telephone number, and the telephone number.

30. The computer-readable medium of claim 26, the computer-readable information associated with an ad further comprising:
d) a telephone number,
wherein the offer information includes a maximum offer, subject to discounting, per establishment of a telephone call between an entered call-back telephone number, and the telephone number.
